(19) United States
(12) Patent Application Publication
(10) Pub. No.: US 2012/0139878 A1
(43) Pub. Date: Jun. 7, 2012

(54) TOUCH MODULE AND TOUCH DISPLAY APPARATUS

(75) Inventors: Chih-Jen Tsang, Hsin-Chu (TW); Yung-Lung Liu, Hsin-Chu (TW)

(73) Assignee: YOUNG LIGHTING TECHNOLOGY CORPORATION, Hsin-Chu (TW)

(21) Appl. No.: 13/303,152

(22) Filed: Nov. 23, 2011

(30) Foreign Application Priority Data
Dec. 6, 2010 (CN) 201010582711.6

(51) Int. Cl. G06F 3/042

(52) U.S. Cl. 345/175

(57) ABSTRACT

A touch module and a touch display apparatus are provided. The touch module includes an image capturing unit, a distance detection unit, and a calculation unit. The image capturing unit determines a touch angle according to a captured detection image. The distance detection unit includes a detection signal generator and a receiver. The detection signal generator supplies a scattered detection signal. The receiver receives the reflected detection signal and determines a first touch distance according to the detection signal. The calculation unit is coupled to the image capturing unit and the distance detection unit. The calculation unit calculates a touch position according to the touch angle and the first touch distance.

### CROSS-REFERENCE TO RELATED APPLICATION

This application claims the priority benefit of China application serial no. 201010582711.6, filed on Dec. 6, 2010. The entirety of the above-mentioned patent application is hereby incorporated by reference herein and made a part of this specification.

### BACKGROUND OF THE INVENTION

1. Field of the Invention

The invention generally relates to a touch module and a touch display apparatus, and more particularly, to a touch module with a distance detection unit and a touch display apparatus.

2. Description of Related Art

Touch panels may be categorized into resistive touch panels, capacitive touch panels, optical touch panels, acoustic wave touch panels, and electromagnetic touch panels based on their touch sensing techniques. Because the touch mechanisms of the optical touch panels is adaptive to large display panels, the touch functions of the large display panels are usually achieved through the optical touch mechanisms. Generally speaking, an optical touch panel usually adopts an infrared light as light source and image capturing devices as touch sensing devices, wherein the image capturing devices are usually disposed at least two corners of the detection area, and the position of a touch point is determined by detecting the infrared light with the image capturing devices.

Different optical touch panels are respectively disclosed in U.S. Pat. Nos. 7,411,575, 6,972,401, 6,803,906, and 6,791,700, and in each of foregoing patent disclosures, image capturing devices are disposed at least two corners of the detection area as touch sensing devices. Additionally, an optical touch panel is also disclosed in Taiwan public patent No. 201015404, wherein a plurality of touch sensing devices is respectively disposed at four sides of the detection area.

### SUMMARY OF THE INVENTION

Accordingly, the invention is directed to a touch module and a touch display apparatus, wherein a touch position is detected by using an image capturing unit and a distance detection unit.

Additional aspects and/or advantages of the invention will be set forth in part in the description which follows and, in part, will be obvious from the description, or may be learned by practice of the invention.

To achieve one of or all aforementioned and other advantages, an embodiment of the invention provides a touch module including an image capturing unit, a distance detection unit, and a calculation unit. The image capturing unit determines a touch angle according to a detection image captured by the image capturing unit. The distance detection unit includes a detection signal generator and a receiver. The detection signal generator supplies a scattered detection signal. The receiver receives a reflected detection signal and determines a first touch distance according to the reflected detection signal. The calculation unit is coupled to the image capturing unit and the distance detection unit. The calculation unit calculates a touch position according to the touch angle and the first touch distance.

To achieve one of or all aforementioned and other advantages, an embodiment of the invention provides a touch display apparatus including a display panel and a touch module. The display panel has a detection area. The touch module includes an image capturing unit, a distance detection unit, and a calculation unit. The image capturing unit is disposed corresponding to a first corner of the detection area. The image capturing unit determines a touch angle according to a detection image captured by the image capturing unit. The distance detection unit is disposed corresponding to a second corner of the detection area. The distance detection unit includes a detection signal generator and a receiver. The detection signal generator supplies a scattered detection signal. The receiver receives the reflected detection signal and determines a first touch distance according to the detection signal. The calculation unit is coupled to the image capturing unit and the distance detection unit. The calculation unit calculates a touch position according to the touch angle and the first touch distance.

In summary, the touch module and the touch display apparatus provided by embodiments of the invention have at least one of following advantages.

In the touch module and the touch display apparatus provided by embodiments of the invention, the touch angle of a touch point is determined by using an image capturing unit, the first touch distance of the touch point is determined by using a distance detection unit, and the touch position of the touch point is calculated according to the touch angle and the first touch distance.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system diagram of a touch display apparatus according to an embodiment of the invention.

FIG. 2 is a diagram illustrating the structure of an image capturing unit according to an embodiment of the invention.

FIG. 3 is a diagram illustrating the structure of a distance detection unit according to an embodiment of the invention.

FIG. 4 is a diagram illustrating the operation states of a detection signal generator and a receiver according to an embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to.” Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

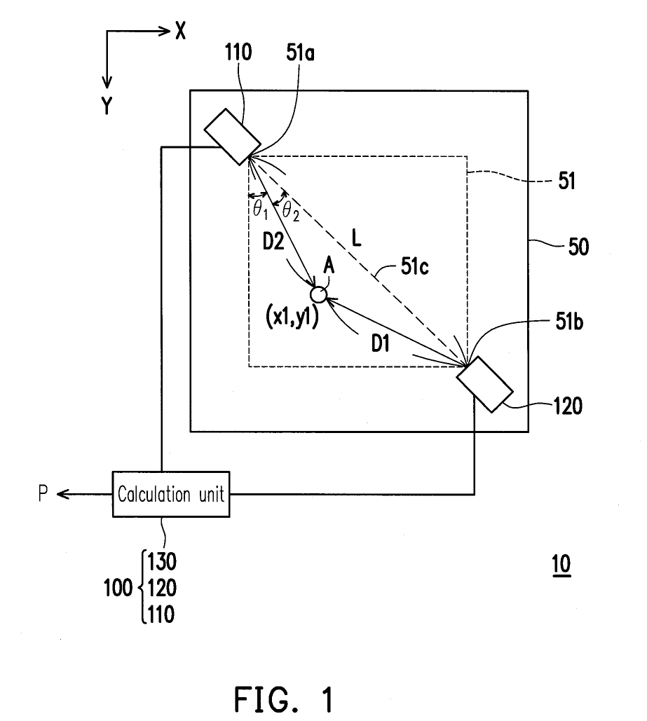

FIG. 1 is a system diagram of a touch display apparatus according to an embodiment of the invention. Referring to FIG. 1, the touch display apparatus 10 includes a display panel 50 and a touch module 100. The display panel 50 has a detection area 51, wherein the detection area 51 may be the display area of the display panel 50. The touch module 100 includes an image capturing unit 110, a distance detection unit 120, and a calculation unit 130. A disposition position of the image capturing unit 110 is corresponding to a first corner 51a of the detection area 51, and a disposition position of the distance detection unit 120 is corresponding to a second corner 51b of the detection area 51. As shown in FIG. 1, the first corner 51a and the second corner 51b are diagonal to each other.

The image capturing unit 110 captures a detection image and determines a touch angle θ₁ of a touch point A according to the detection image. To be specific, it is assumed herein that the detection image is belt-shaped and the image capturing unit 110 emits a light beam. When the light beam is reflected by a touching object (for example, a finger) to the image capturing unit 110, a light spot is produced on the detection image. The image capturing unit 110 determines the touch angle θ₁ of the touch point A according to the position of the light spot. The distance detection unit 120 determines a first touch distance D1 of the touch point A. To be specific, the distance detection unit 120 supplies a scattered detection signal (for example, an optical signal or an acoustic signal). When the detection signal is reflected by the touching object (for example, a finger) to the distance detection unit 120, the distance detection unit 120 calculates the first touch distance D1 based on the difference between the time of emitting the detection signal and the time of receiving the reflected detection signal.

The calculation unit 130 is coupled to the image capturing unit 110 and the distance detection unit 120. The calculation unit 130 calculates a touch position of the touch point A according to the touch angle θ₁ and the first touch distance D1 and generates a touch signal P according to the touch position. To be specific, if the touch point A is touched, the image capturing unit 110 determines the touch angle θ₁ of the touch point A, and the distance detection unit 120 determines the first touch distance D1 of the touch point A. In addition, the diagonal 51c of the detection area 51 has a fixed angle (i.e., θ₁+θ₂), and the angle of the diagonal 51c may be obtained through measurement when the display panel 50 is manufactured. Thus, the angle θ₂ may be obtained through calculation after the touch angle θ₁ is obtained. Then, a second touch distance D2 is calculated according to the angle θ₂, the length L of the diagonal 51c, and the first touch distance D1, and the positions of the touch point A respectively corresponding to the axis X (i.e., the first axial direction) and the axis Y (i.e., the second axial direction) (i.e., the position x1 of the touch point A corresponding to the axis X and the position y1 of the touch point A corresponding to the axis Y) are calculated according to the second touch distance D2 and the touch angle θ₁, which are respectively expressed as:

D2=L×cos θ₂−\sqrt{(L×cos θ₂)²−(L²−D1²)}

x1=D2×sin θ₁

y1=D2×cos θ₁

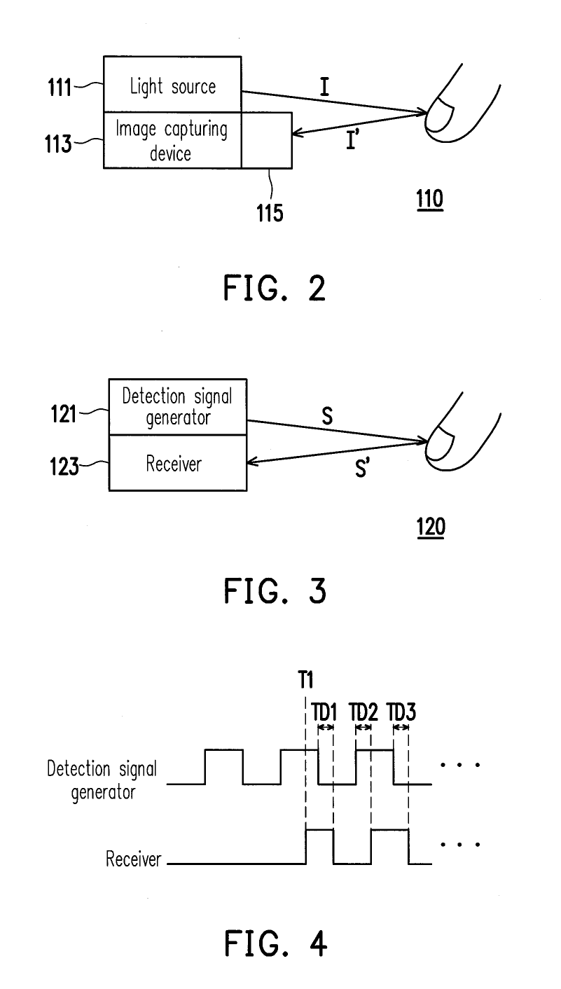

FIG. 2 is a diagram illustrating the structure of an image capturing unit according to an embodiment of the invention. Referring to FIG. 2, in the embodiment, the image capturing unit 110 includes a light source 111, an image capturing device 113, and a lens 115, wherein the light source 111 is mounted on the image capturing device 113. The light source 111 supplies a scattered light beam I, wherein the light beam I is an infrared light beam when the light source 111 is an infrared light source. The lens 115 guides the reflected light beam I′ into the image capturing device 113 so that the image capturing angle of the image capturing device 113 may be greater than 90°. The image capturing device 113 captures a detection image and determines a touch angle according to the detection image.

FIG. 3 is a diagram illustrating the structure of a distance detection unit according to an embodiment of the invention. Referring to FIG. 3, in the embodiment, the distance detection unit 120 includes a detection signal generator 121 and a receiver 123. The detection signal generator 121 supplies a scattered detection signal S. Herein the detection signal S is an infrared signal when the detection signal generator 121 is an infrared light source, and the detection signal S is an acoustic signal when the detection signal generator 121 is a sound source (for example, a speaker). The receiver 123 receives the reflected detection signal S′ and determines the first touch distance D1 (illustrated in FIG. 1) according to the reception status. Herein the receiver 123 includes an optical detector (for example, a photo diode) when the detection signal S is an infrared signal, and the receiver 123 includes a microphone when the detection signal S is an acoustic signal.

FIG. 4 is a diagram illustrating the operation states of a detection signal generator and a receiver according to an embodiment of the invention. Referring to FIG. 3 and FIG. 4, when the detection signal generator 121 is at a high voltage level, it supplies a scattered detection signal S, and when the detection signal generator 121 is at a low voltage level, it stops supplying the detection signal S. When the receiver 123 is at a high voltage level, it receives the reflected detection signal S′, and when the receiver 123 is at a low voltage level, it does not receive the reflected detection signal S′. When a user touches the touch display apparatus by using a touching object (for example, a finger), the receiver 123 receives the reflected detection signal S′.

Assuming that the receiver 123 receives the reflected detection signal S′ at the time point T1. At the detection signal generator 121 stops supplying the scattered detection signal S, since it takes time for the detection signal S to reach the receiver 123 (i.e., the detection signal S′) through the reflection of the touching object, a time difference TD1 is produced. Subsequently, time differences TD2 and TD3 are produced when the detection signal generator 121 starts and stops supplying the detection signal S. More time differences will be produced if the touching object touches the touch display apparatus for a longer time. After the receiver 123 obtains a plurality of time differences (for example, the time differences TD1, TD2, and TD3), the receiver 123 calculates the first touch distance D1 according to one or all of the obtained time differences (for example, the time differences TD1, TD2, and TD3).

To be specific, when the detection signal S is an infrared signal, the first touch distance D1 is calculated by multiplying the light velocity by one of foregoing time differences or by multiplying the light velocity by an average value of foregoing time differences. When the detection signal S is an acoustic signal, the first touch distance D1 is calculated by multiplying the sound velocity by one of the foregoing time differences or by multiplying the sound velocity by an average value of foregoing time differences.

Additionally, the touch angle θ₁ is determined by the image capturing device 113 in the embodiments described above. However, in other embodiments, the touch angle θ₁ may also be determined by the calculation unit 130. Moreover, the first touch distance D1 is determined by the receiver 123 in the embodiments described above. However, in other embodiments, the first touch distance D1 may also be determined by the calculation unit 130.

In summary, the touch module and the touch display apparatus provided by embodiments of the invention have at least one of following advantages.

In the touch module and the touch display apparatus provided by embodiments of the invention, the touch angle of a touch point is determined by using an image capturing unit, the first touch distance of the touch point is determined by using a distance detection unit, and the touch position of the touch point is calculated according to the touch angle and the first touch distance.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention,” “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first,” “second,” etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A touch module, comprising:
an image capturing unit, for determining a touch angle according to a detection image captured by the image capturing unit;
a distance detection unit, comprising:
a detection signal generator, for supplying a scattered detection signal; and
a receiver, for receiving a reflected detection signal and determining a first touch distance according to the reflected detection signal; and
a calculation unit, coupled to the image capturing unit and the distance detection unit, for calculating a touch position according to the touch angle and the first touch distance.

2. The touch module according to claim 1, wherein the detection signal generator comprises a light source, the detection signal comprises an optical signal, and the receiver comprises an optical detector.

3. The touch module according to claim 2, wherein the detection signal comprises an infrared signal.

4. The touch module according to claim 1, wherein the detection signal generator comprises a sound source, the detection signal comprises an acoustic signal, and the receiver comprises a microphone.

5. The touch module according to claim 1, wherein a disposition position of the image capturing unit is corresponding to a first corner of a detection area and a disposition position of the distance detection unit is corresponding to a second corner of the detection area, wherein the first corner and the second corner are diagonal to each other.

6. The touch module according to claim 1, wherein the calculation unit calculates a second touch distance according to the touch angle and the first touch distance and calculates a first axial position and a second axial position of the touch position according to the second touch distance.

7. The touch module according to claim 1, wherein the image capturing unit further comprises:
an image capturing device, for capturing the detection image and determining the touch angle according to the detection image;
a light source, mounted on the image capturing device and supplying a scattered light beam; and
a lens, for guiding a reflected light beam into the image capturing device.

8. The touch module according to claim 1, wherein the detection signal generator supplies the scattered detection signal when the detection signal generator is at a high voltage level, the detection signal generator stops supplying the detection signal when the detection signal generator is at a low voltage level, and the receiver receives the reflected detection signal when the receiver is at a high voltage level, the receiver does not receive the reflected detection signal when the receiver is at a low voltage level.

9. A touch display apparatus, comprising:
a display panel, having a detection area; and
a touch module, comprising:
an image capturing unit, disposed at a first corner corresponding to the detection area, for determining a touch angle according to a detection image captured by the image capturing unit;
a distance detection unit, disposed at a second corner corresponding to the detection area, the distance detection unit comprising:
a detection signal generator, for supplying a scattered detection signal; and
a receiver, for receiving a reflected detection signal and determining a first touch distance according to the reflected detection signal; and
a calculation unit, coupled to the image capturing unit and the distance detection unit, for calculating a touch position according to the touch angle and the first touch distance.

10. The touch display apparatus according to claim 9, wherein the detection signal generator comprises a light source, the detection signal comprises an optical signal, and the receiver comprises an optical detector.

11. The touch display apparatus according to claim 10, wherein the detection signal comprises an infrared signal.

12. The touch display apparatus according to claim 9, wherein the detection signal generator comprises a sound source, the detection signal comprises an acoustic signal, and the receiver comprises a microphone.

13. The touch display apparatus according to claim 9, wherein the first corner and the second corner are diagonal to each other.

14. The touch display apparatus according to claim 9, wherein the calculation unit calculates a second touch distance according to the touch angle and the first touch distance and calculates a first axial position and a second axial position of the touch position according to the second touch distance.

15. The touch display apparatus according to claim 9, wherein the image capturing unit further comprises:
an image capturing device, for capturing the detection image and determining the touch angle according to the detection image;
a light source, mounted on the image capturing device and supplying a scattered light beam; and
a lens, for guiding a reflected light beam into the image capturing device.

16. The touch display apparatus according to claim 9, wherein the detection signal generator supplies the scattered detection signal when the detection signal generator is at a high voltage level, the detection signal generator stops supplying the detection signal when the detection signal generator is at a low voltage level, and the receiver receives the reflected detection signal when the receiver is at a high voltage level, the receiver does not receive the reflected detection signal when the receiver is at a low voltage level.
